(19) United States
(12) Patent Application Publication
(10) Pub. No.: US 2022/0286748 A1
(43) Pub. Date: Sep. 8, 2022

(54) METHOD THAT PROVIDES AN AUDIENCE WITH A TOOL THAT ALLOWS THEM TO INTELLIGENTLY COMMUNICATE WITH EACH OTHER DURING A LIVE STREAMING EVENT

(71) Applicants: JENNIFER DYER, Los Angeles, CA (US); Kiaran Sim, Los Angeles, CA (US)

(72) Inventors: JENNIFER DYER, Los Angeles, CA (US); Kiaran Sim, Los Angeles, CA (US)

(21) Appl. No.: 17/190,338

(22) Filed: Mar. 2, 2021

(51) Int. Cl. H04N 21/4788; H04N 21/2187; H04N 21/81; H04N 21/485; H04N 21/431; H04N 21/454

(52) U.S. Cl. CPC H04N 21/4788; H04N 21/2187; H04N 21/812; H04N 21/4854; H04N 21/4316; H04N 21/454

(57) ABSTRACT

A method that rewards viewers watching a live streaming event with the ability to see real-time video comments posted by other viewers of the live streaming event and that allows real-time video comments receiving positive feedback to remain for longer periods on the screen of the live streaming event. The invention also allows advertisers to gauge the relationship between the events that led to the real-time video comment receiving positive or negative reviews and then bidding on advertisements that will be published near the time slot and ad space in which the events of the real-time video comment was published.

### BACKGROUND

The present invention is directed to a method that provides an audience with a tool that allows them to intelligently communicate with each other during a live streaming event.

The method of the present invention aims to allow viewers to post real-time video comments that express their reactions to live streaming events that can be seen by the viewers of the event. The method of the present invention shall be implemented by installing a plugin on a platform that is providing the live streaming event.

Upon the viewers of the live streaming event commenting on any real-time video comment posted, by either clicking on the real-time video or commenting on the real-time video, the audience of the live streaming event will notice an outer border of the real-time video change color.

The outer border shall inform the viewers of the live streaming event the value of the real-time video comment in relation to what is being live streamed at an approximate time of the live streaming event.

The platform hosting the live streaming event shall have moderators that will moderate the audio and/or video of the real-time video comments to flag any questionable, disruptive, or negative feedback that is posted in any video comment.

The platform will also allow the moderators to publish advertisements that correspond with positive or negative video comments during the live streaming event.

The present invention will allow an audience to develop a positive or negative group conscience of events being transmitted during the live streaming event. Events shall be defined as specific instances during the live streaming event that cause viewers to post video comments.

The present invention also allows the moderators to place advertisements during specific events of the live streaming event that will correspond to the color shown in the outer border of the real-time video comments. Advertisers will be allowed to bid on the color of the outer borders wherein they will choose to have their advertisements shown during the live streaming event.

Real-time video comments receiving positive feedback will be rewarded by allowing the real-time video comments to loop for a set period that will correspond to the events that led to the positive feedback.

The method of the present invention will allow advertisers to bid on advertising on a specific time slot and ad space while the live streaming event is being published, thereby allowing advertisers the ability to know that their advertisement is being seen by an audience that may be receptive to their products or to the message that they wish to share with the viewing public at a specific point in time.

### SUMMARY

The present invention is directed to a method that rewards viewers watching a live streaming event with the ability to see real-time video comments posted by other viewers of the live streaming event and that allows real-time video comments receiving positive feedback to remain for longer periods on the screen of the live streaming event. The invention also allows advertisers to gauge the relationship between the events that led to the real-time video comment receiving positive or negative reviews and then bidding on advertisements that will be published near the time slot and ad space in which the events of the real-time video comment was published.

The method of the present invention shall be implemented by having an application that shall be plugged into the platform that is publishing the live streaming event. The publisher of the live streaming event shall have moderating tools that will allow them to flag videos that show inappropriate content, as determined by the publisher of the live streaming event.

An object of the present invention is to provide a method that allows viewers ofa live streaming event to post real-time video comments that correspond to events during the live streaming event.

Another object of the present invention is to provide a method that an audience can gauge the importance of real-time video comments posted during the live streaming event.

Yet another object of the present invention is to provide a method that will allow advertisers the right to bid on time slot and ad space for advertisements that correspond to positive or negative feedback of any real-time video comment.

Yet still another object of the present invention is to provide a method wherein moderators of the live streaming event can place advertisements during the live streaming event that correspond to the real-time video comments of the users.

### DRAWINGS

These and other features, aspects, and advantages of the present invention will become better understood with regards to the following description, appended claims, and drawings where:

FIG. 1 is a flowchart that helps explains claim 1 of the present invention;

FIG. 2 is a flow chart that helps explains claim 3 of the present application;

FIG. 3 is a flow chart that helps explain claims 5 and 6 of the present application;

FIG. 4 is a flow chart that helps explain claim 7 of the present application;

FIG. 5 is a flow chart that helps explain claim 8 of the present application;

FIG. 6 is a flow chart that helps explain claim 9 of the present application; and

FIG. 7 is a flow chart that helps explain claim 10 of the present application.

### DESCRIPTION

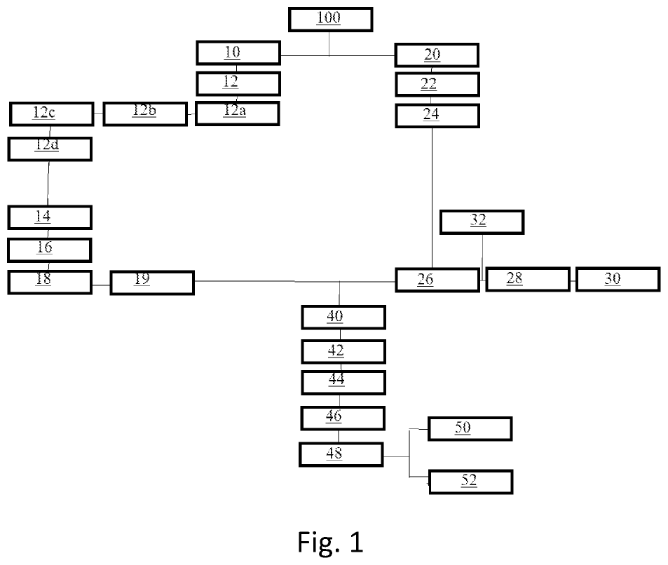

As seen in FIGS. 1-7, the present invention is a method that provides an audience with a tool that allows them to communicate with each other during a live streaming event, the method comprises of providing a live video streaming event; providing a platform that will allow a plurality of viewers that are seeing the event to upload a real-time video comment of the event; providing a background in which the real-time video comment will be published on the live video streaming event, the background can be any type of geometrical figure and the background will have an outer border that will change colors upon any of the plurality of viewers clicking on the real-time video comment; instructing the plurality of viewers viewing the live video streaming event to upload a video comment that will have an audio and/or a video; providing first moderator that will analyze the audio that was uploaded by any of the plurality of viewers; providing a second moderator that will analyze the video that was uploaded by the plurality of viewers; providing a publisher that will publish the real-time video comment on the live video streaming event for a set period that will give other viewers a chance to react to the real-time video comment; and publishing the real-time video comment on the live video streaming event so that the real-time video comment is within the background and so that the outer border of the background changes colors as any of the plurality of viewers of the live video streaming event reacts to the real-time video comment.

In an embodiment of the present invention, the live video streaming event can be either a concert, a sporting event, a news event, a forum, a debate, a talent show, a game show, a beauty contest, or a class.

In another embodiment of the invention, the platform will be added to the live video streaming event by a presenter of the live video streaming event by uploading a plugin of the platform to a program that is used by the video live streaming event.

In yet another embodiment of the present invention, the outer border of the background will turn colors depending on the positive or negative feedback of the plurality viewers of the video comment and includes a defining color chart that will allow the plurality of viewers to understand a value given by the plurality of viewers of the live video streaming event.

In yet still another embodiment of the present invention, the first moderator will flag and not publish any audio having any questionable, disruptive, or offensive content that was uploaded by any of the plurality of viewers, and wherein the first moderator will warn any of the plurality of viewers publishing the flagged content that a second violation shall kick them out of the platform.

In a further embodiment of the present invention, the second moderator will flag and not publish any video having any questionable, disruptive or offensive content that was uploaded by any of the plurality of viewers, and wherein the second moderator will warn any of the plurality of viewers publishing the flagged content that a second violation shall kick them out of the platform.

In yet a further embodiment of the present invention, the real-time video comment published is published on the live video streaming event so that it starts on a periphery of a screen wherein the live video streaming event is published and ends on an opposite side of the periphery of the screen, and wherein any real-time video comment receiving a positive feedback will remain for a longer period on the screen of the live streaming event.

In yet still a further embodiment of the present invention, the invention shall further comprise of providing a plurality of advertisements that shall be published during the live video streaming events, the plurality of advertisements shall be associated to any positive feedback to any uploaded video comment, and publishing any of the plurality of advertisements when either the first moderator or the second moderator perceives that the positive feedback can be associated with any of the advertisements.

In an additional embodiment of the present invention, the invention shall further comprise of allowing any of the plurality of viewers to upload a viewer comment to any uploaded real-time video comment. In this embodiment the viewer comment can be a text, an emoji, a video, or an audio upload.

In yet still an additional embodiment, the invention shall further comprise of providing a bidding module wherein advertisers can bid on a time slot and ad space for an advertisement that corresponds to a color of the outer border during the presentation of the live streaming event.

Explanation of Clam 1:

FIG. 1 discloses a first embodiment of the present invention. In FIG. 1, we begin with accepting that premise that 1 the widget of the present invention has been configured for the event 100, using the Admin. We also accept the premise that there may exist a new feature for recording specific reactions and not just yaps. Yaps inside this widget will only be video yaps. Audio Yaps are not allowed for live events.

This is a reaction 10
The user is asked to choose from different options how they feel or they may choose to skip it 12.
   Automatic Moodring (Sentiment Analysis) 12a.
   Based on an automatic analysis of video files uploaded, the system determines the uploader's mood 12b.
   The result is compared with our systems definitions. If the user decided to skip how they felt, the system will use the previously determined mood by the system 12c.
The system adds the chosen option to the reaction bubble 12d.
The compared results are used to train the AI for more accurate mood analysis on its adaptive learning 14.
Moodring will be displayed in the bubbles reaction stream 16.
The User records a reaction 18, reaction_can only be up to 4 seconds

The reaction is added to the bubbles but it's not part of the conversation that happens on the widget 19. A reaction is a bubble containing a user created animation.
This is a Yap 20
The User records a Yap 22.
The Yap is added to the conversation inside the widget 24.
A new bubble with the user's profile picture will show 26.
   Someone decides to click on the profile picture that appears in the bubble 28.
   The bubble redirects the user to more consumable content within the same page 30.
   The Yap may be shown as an animation like with a reaction 32.

Once the recording is finished the bubbles will join in the right panel 40.

The system will leave the comment for moderation, which can be processed manually or using AI software 42.

Does the user wish to record again? 44

As the event keeps going, more bubbles show up in the event. Users may choose to see conversations as well 46

The event ends 48
Yaps will be available for download in the admin, like with any other widget 50.
Reactions will have their own section so Publishers may download this content and use it for media releases 52.

Explanation of Claim 3:

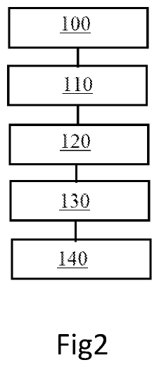

FIG. 2 explains how the publisher creates a live streaming event and sets up the live streaming event for public viewing:
1. A publisher decides to create a live streaming event 100.
2. The Publisher goes to the live events section and clicks on “Add Event.” 110
3. The Publishes completes the required information for the event. 120
4. By clicking the save button, the system will provide an insertion code for the Web Master to include on the Event's website. 130
5. The event will begin by clicking on “Start Event” on the Actions menu. 140

Explanation of Claims 5 and 6:

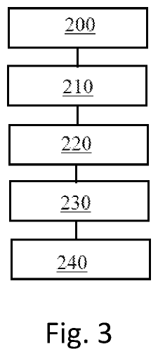

FIG. 3 explains the content moderation disclosed in claims 5 and 6 of the present invention:
1. User wishes to create a reaction. 200
2. The User taps on record reaction. 210
3. The user is asked to choose from different options how they feel or they may choose to skip it. 220
   3.1 Automatic Moodring (Sentiment Analysis). Based on an automatic analysis of video files uploaded, the system determines the uploader's mood. The result is compared with our systems definitions. If the user decided to skip how they felt, the system will use the previously determined mood by the system.
   3.2 The system adds the chosen option to the reaction bubble.
4. The compared results are used to train the AI for more accurate mood analysis on its adaptive learning. 230
5. The Moodring is displayed in the bubbles reaction stream. 240

Explanation of Claim 7:

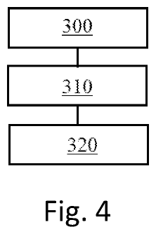

FIG. 4 explains how the administrator or system chooses to upload the live contents into the live streaming event.
1. The Event's host decides to play specific content coming from the live comments stream into the live stream video. 300
2. Inside the Administration tool, under the live events section, the Host chooses a comment inside the comments list to show in a live feed. 310
3. By clicking on “Send to Live Stream” the media comment is shown on the bottom side of the screen. 320

Explanation of Claim 8:

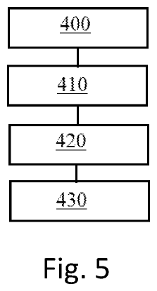

FIG. 5 explains how ads and sponsored content is selected and displayed during the live streaming event:
1. The Publisher wishes to add specific Ads or Sponsored content to feature in the Bubbles Stream or Conversations section of a Live event. 400
2 The publisher uploads the sponsored content which is shown on a list with different actions. 410
3 When the Publisher decides, they can trigger the desired Ad or Sponsored content. 420
4 The content is displayed. 430
   a. Background
   b. Yapps
   c. Special insertions
   d. Sidebar
   e. Special Mood Rings
   f. Badges

Explanation of Claim 9:

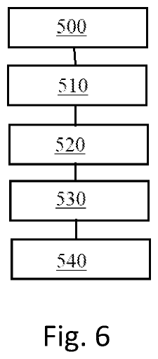

FIG. 6 explains how a user comments during the live streaming event:
1. A user decides to comment on an existing video-comment. 500
2. The user sees a comment they wish to reply to, and chooses “Reply Thread.” 510
3. The user is asked to choose from different options how they feel or they may choose to skip it._520
4. The system the opens the video recorder in which the user proceeds to create the reply. 530
5. The resulting new comment is then moderated and uploaded into the system, displaying a distinct mark that confirms this is the reply of a specific comment inside a conversation. 540

Explanation of Claim 10:

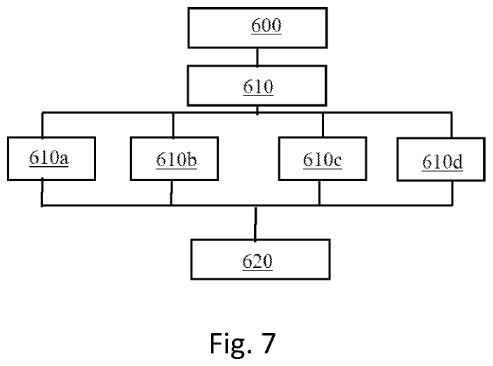

FIG. 7 explain how a user chooses to create content during the live streaming event:
1. The User decides to create content either by beginning a thread or replying to one. 600
2. When creating new content, the system will let the user choose from different media comment options: 610
   Emoji comment; 610a
   Video comment; 610b
   Audio comment; 610c or
   Text comment. 610d
3. Once the selection has been made, the system will moderate and later add the comment in the Event's stream. 620

An advantage of the present invention is that it provides a method that allows viewers of a live streaming event to post real-time video comments that correspond to events during the live streaming event.

Another advantage of the present invention is that it provides a method in which an audience can gauge the importance of real-time video comments posted during the live streaming event.

Yet another advantage of the present invention is that it provides a method that will allow advertisers the right to bid on time slots and ad space for advertisements that correspond to positive or negative feedback of any real-time video comment.

Yet still another advantage of the present invention is that it provides a method wherein moderators of the live streaming event can place advertisements during the live streaming event that correspond to the real-time video comments of the users.

The embodiments of the apparatus and method of use described herein are exemplary and numerous modifications, combinations, variations, and rearrangements can be readily envisioned to achieve an equivalent result, all of which are intended to be embraced within the scope of the appended claims. Further, nothing in the above-provided discussions of the apparatus and method should be construed as limiting the invention to a particular embodiment or combination of embodiments. The scope of the invention is defined by the appended claims, the written description, and the drawings of the present application.

What is claimed is:

1. A method that provides an audience with a tool that allows them to communicate with each other during a live streaming event, the method comprising:
providing a live video streaming event;
providing a platform that will allow a plurality of viewers that are seeing the event to upload a real-time video comment of the event;
providing a background in which the real-time video comment will be published on the live video streaming event, the background can be any type of geometrical figure and the background will have an outer border that will change colors upon any of the plurality of viewers clicking on the real-time video comment;
instructing the plurality of viewers viewing the live video streaming event to upload a video comment that will have an audio and/or a video;
providing a first moderator that will analyze the audio that was uploaded by any of the plurality of viewers;
providing a second moderator that will analyze the video that was uploaded by the plurality of viewers;
providing a publisher that will publish the real-time video comment on the live video streaming event for a set period that will give other viewers a chance to react to the real-time video comment; and
publishing the real-time video comment on the live video streaming event so that the real-time video comment is within the background and so that the outer border of the background changes colors as any of the plurality of viewers of the live video streaming event reacts to the real-time video comment.

2. The method that provides an audience with a tool that allows them to communicate with each other during a live streaming event of claim 1, wherein the live video streaming event can be either a concert, a sporting event, a news event, a forum, a debate, a talent show, a game show, a beauty contest, or a class.

3. The method that provides an audience with a tool that allows them to communicate with each other during a live streaming event of claim 1,. wherein the platform will be added to the live video streaming event by a presenter of the live video streaming event by uploading a plugin of the platform to a program that is used by the video live streaming event.

4. The method that provides an audience with a tool that allows them to communicate with each other during a live streaming event of claim 1, wherein the outer border of the background will turn colors depending on the positive or negative feedback of the plurality viewers of the video comment and defining a color chart that will allow the plurality of viewers to understand a value given by the plurality of viewers of the live video streaming event.

5. The method that provides an audience with a tool that allows them to communicate with each other during a live streaming event of claim 1, wherein the first moderator will flag and not publish any audio having any questionable, disruptive, or offensive content that was uploaded by any of the plurality of viewers, and wherein the first moderator will want any of the plurality of viewers publishing the flagged content that a second violation shall kick them out of the platform.

6. The method that provides an audience with a tool that allows them to communicate with each other during a live streaming event of claim 1, wherein the second moderator will flag and not publish any video having any questionable, disruptive, or offensive content that was uploaded by any of the plurality of viewers, and wherein the second moderator will warn any of the plurality of viewers publishing the flagged content that a second violation shall kick them out of the platform.

7. The method that provides an audience with a tool that allows them to communicate with each other during a live streaming event of claim 1, wherein the real-time video comment is published on the live video streaming event so that it starts on a periphery of a screen wherein the live video streaming event is published and ends on an opposite side of the periphery of the screen, and wherein any real-time video comment receiving a positive feedback will remain for a longer period on the screen of the live streaming event.

8. The method that provides an audience with a tool that allows them to communicate with each other during a live streaming event of claim 1, comprises of providing a plurality of advertisements that shall be published during the live video streaming events, the plurality of advertisements shall be associated to any positive feedback to any uploaded video comment, and publishing any of the plurality of advertisements when either the first moderator or the second moderator perceives the positive feedback can be associated with any of the advertisements.

9. The method that provides an audience with a tool that allows them to communicate with each other during a live streaming event of claim 1, comprises of allowing any of the plurality of viewers to upload a viewer comment to any uploaded real-time video comment.

10. The method that provides an audience with a tool that allows them to communicate with each other during a live streaming event of claim 9, wherein the viewer comment can be a text, an emoji, a video, or an audio upload. 11. The method that provides an audience with a tool that allows them to communicate with each other during a live streaming event of claim I, further comprises of providing a bidding module wherein advertisers can bid on a time slot and ad space for an advertisement that corresponds to a color of the outer border during the presentation of the live streaming event.
